(19) United States
(12) Patent Application Publication
(10) Pub. No.: US 2025/0033519 A1
(43) Pub. Date: Jan. 30, 2025

(54) UTILIZING HOT-SWAP BATTERY SYSTEMS IN ELECTRIC FIREFIGHTING ROBOTIC VEHICLES

(71) Applicant: Howe & Howe Inc., Waterboro, ME (US)

(72) Inventor: Timothy Merlin Foley, Lyman, ME (US)

(21) Appl. No.: 18/783,943

(22) Filed: Jul. 25, 2024

Related U.S. Application Data
(60) Provisional application No. 63/528,946, filed on Jul. 26, 2023.

(51) Int. Cl. B60L 53/80; A62C 27/00; B60K 1/02; B60L 50/64; B60S 5/06

(52) U.S. Cl. CPC B60L 53/80; A62C 27/00; B60K 1/02; B60L 50/64; B60S 5/06

(57) ABSTRACT

An electric firefighting robotic vehicle includes a vehicle frame constructed and arranged to support firefighting equipment, and a set of electric motors supported by the vehicle frame to provide firefighting robotic vehicle propulsion. The electric firefighting robotic vehicle further includes a battery assembly supported by the vehicle frame. The battery assembly includes a battery chassis supported by the vehicle frame, the battery chassis defining a set of hot-swappable slots to house a set of batteries which stores electric power to operate the set of electric motors; a door constructed and arranged to cover (i) a set of slot openings to the set of hot-swappable slots defined by the battery chassis and (ii) the set of batteries when the set of batteries is housed within the set of hot-swappable slots; and hardware which couples the door with the battery chassis.

### CROSS REFERENCE TO RELATED APPLICATIONS

This application is a regular utility application based on earlier-filed U.S. Application No. 63/528,946 filed on Jul. 26, 2023, entitled “Hot Swap Battery System for Electric Firefighting Robot”, the contents and teachings of which are hereby incorporated by reference in their entirety.

### FIELD

This disclosure relates generally to vehicle designs, and more particularly to techniques involving replacing sets of batteries on electric firefighting robotic vehicles.

### BACKGROUND

Firefighting robots are specially adapted vehicles for spraying water on fires. Typically, such firefighting robots engage burning targets under combustion engine power (e.g., running on gasoline or diesel fuel).

Smaller than firetrucks, firefighting robots are maneuverable and able to aim water accurately at desired targets. For example, some firefighting robots may take the form of remote controlled, tracked vehicles with remotely aimed nozzles (monitors) that can discharge 1,500 gallons or more of water per minute. Such firefighting robots have the ability to withstand environments that are too hazardous for human personnel.

### SUMMARY

It should be appreciated that gasoline and diesel fuels are highly flammable and thus can pose safety risks when located and/or handled in excessively hot environments or in spaces where there are open flames. In addition, gasoline and diesel engines tend to provide low torque at low speeds, but sometimes firefighting vehicles can benefit from high torque at low speeds, such as when climbing over obstacles or when dragging water-charged hoses or heavy equipment. Further, adding gasoline or diesel exhaust to an environment already filled with toxic smoke does not help to promote the health and well-being of trapped people or animals or of personnel in the vicinity of the vehicle. Further still, performance of combustion engines can degrade markedly in smoke-filled spaces, which may contain many contaminants and may be starved of oxygen.

Improved techniques involve electric firefighting robotic vehicles provisioned with hot-swap battery systems. Along these lines, such hot-swap battery systems allow batteries having states of charge that have dropped to low states (e.g., due to vehicle operation) to be quickly and easily replaced with charged batteries (e.g., by pulling spent batteries out of slots at the rears of the vehicles and inserting fully charged batteries into the slots in their place). Such replacement may be performed in the field to extend use time for as long as charged batteries are on hand. Accordingly, there is no need to wait for discharged batteries to be recharged. Moreover, in contrast to combustion-based firefighting robotic vehicles, there is no need to refill vehicle fuel tanks or deal with the various risks associated with locating and/or handling volatile/combustible fuels such as gasoline and diesel in dangerous environments.

One embodiment is directed to an electric firefighting robotic vehicle which includes a vehicle frame constructed and arranged to support firefighting equipment. The electric firefighting robotic vehicle further includes a set of electric motors supported by the vehicle frame to provide firefighting robotic vehicle propulsion. The electric firefighting robotic vehicle further includes a battery assembly constructed and arranged to provide electric power to the set of electric motors. The battery assembly includes:
(A) a battery chassis defining a set of hot-swappable slots to house a set of batteries which stores the electric power,
(B) a door constructed and arranged to cover (i) a set of slot openings to the set of hot-swappable slots defined by the battery chassis and (ii) the set of batteries when the set of batteries is housed within the set of hot-swappable slots, and
(C) hardware constructed and arranged to couple the door with the battery chassis.

Another embodiment is directed to a battery assembly for an electric vehicle. The battery assembly includes:
(A) a battery chassis defining a set of hot-swappable slots to house a set of batteries which stores electric power for the electric vehicle;
(B) a door constructed and arranged to cover (i) a set of slot openings to the set of hot-swappable slots defined by the battery chassis and (ii) the set of batteries when the set of batteries is housed within the set of hot-swappable slots; and
(C) hardware which couples the door with the battery chassis.

Yet another embodiment is directed to a method of battery hot-swapping on an electric firefighting robotic vehicle. The method includes inserting a first set of batteries into a set of hot-swappable slots via a back of the electric firefighting robotic vehicle. The method further includes, after the electric firefighting robotic vehicle has discharged electric power from the first set of batteries during firefighting robotic vehicle operation, removing a battery of the first set of batteries from a hot-swappable slot of the set of hot-swappable slots via the back of the electric firefighting robotic vehicle. The method further includes inserting a replacement battery from a second set of batteries in place of the battery removed from a hot-swappable slot, the electric firefighting robotic vehicle operating based on electric power from at least the replacement battery following insertion of the replacement battery.

In some arrangements, the method further includes:
(i) while the replacement battery from the second set of batteries remains inserted in place of the battery removed from the hot-swappable slot, removing another battery of the first set of batteries from another hot-swappable slot of the set of hot-swappable slots via the back of the electric firefighting robotic vehicle; and
(ii) inserting another replacement battery from the second set of batteries in place of the other battery removed from the other hot-swappable slot.

In some arrangements, the battery chassis includes a set of chassis walls defining the set of hot-swappable slots and a set of chassis hinge portions coupled with the set of chassis walls. Additionally, the door includes a cover portion and a set of door hinge portions disposed around a periphery of the cover portion. Furthermore, the hardware includes a set of pins constructed and arranged to couple the set of door hinge portions with the set of chassis hinge portions.

In some arrangements, the set of pins is constructed and arranged to maintain the door in a closed state against the battery chassis when all pins of the set of pins couple the set of door hinge portions with the set of chassis hinge portions.

In some arrangements, the set of pins is constructed and arranged to maintain the door in a first pivoting state relative to the battery chassis when (i) first pins of the set of pins couple door hinge portions on a first side of the cover portion with chassis hinge portions on a first side of the battery chassis and (ii) second pins of the set of pins do not couple door hinge portions on a second side of the cover portion with chassis hinge portions on a second side of the battery chassis.

In some arrangements, the set of pins is constructed and arranged to maintain the door in a second pivoting state relative to the battery chassis when (i) the second pins of the set of pins couple the door hinge portions on the second side of the cover portion with the chassis hinge portions on the second side of the battery chassis and (ii) the first pins of the set of pins do not couple the door hinge portions on the first side of the cover portion with the chassis hinge portions on the first side of the battery chassis. Additionally, the second side of the cover portion is opposite the first side of the cover portion.

In some arrangements, the door is constructed and arranged to fully detach from the battery chassis when none of the set of pins couple the set of door hinge portions with the set of chassis hinge portions.

In some arrangements, the first pins and the second pins are hand-removable L-shaped metal rods.

In some arrangements, the electric firefighting robotic vehicle further includes a winch mounted to an outer side of the cover portion of the door, the winch being constructed and arranged to control winding and unwinding of a cable.

In some arrangements, the hardware further includes a hand-removable central fastener constructed and arranged to fasten a central section of the cover portion of the door to the battery chassis while the door is in the closed state against the battery chassis to add rigidity which supports the winch.

In some arrangements, the door further includes a set of bumpers disposed on an inner side of the cover portion, the set of bumpers being constructed and arranged to inhibit movement of the set of batteries within the battery chassis when the set of batteries is housed within the set of hot-swappable slots.

In some arrangements, the set of bumpers is constructed and arranged to compress between the cover portion and the set of batteries when the set of batteries is housed within the set of hot-swappable slots and the door is held in the closed state against the battery chassis.

In some arrangements, the battery chassis includes a set of chassis walls defining the set of hot-swappable slots, and a set of guides coupled with the set of chassis walls. The set of guides is constructed and arranged to align the set of batteries within the set of hot-swappable slots during insertion of the set of batteries into the set of hot-swappable slots.

In some arrangements, the set of chassis walls includes a left chassis wall, a center chassis wall, and a right chassis wall. The left chassis wall and the center chassis wall define a left hot swappable slot. Additionally, the right chassis wall and the center chassis wall define a right hot swappable slot.

In some arrangements, the set of guides includes a left set of ultra-high molecular weight polyethylene (UHMW) rails coupled with the left chassis wall and the center chassis wall to flank the left hot-swappable slot, and a right set of UHMW rails coupled with the right chassis wall and the center chassis wall to flank the right hot-swappable slot.

In some arrangements, the vehicle frame defines left side, a right side, a front and a back of the electric firefighting robotic vehicle. Additionally, the set of electric motors includes a left electric traction motor that operates a left ground engaging member disposed on the left side of the vehicle, and a right electric traction motor that operates a right ground engaging member disposed on the right side of the vehicle. Furthermore, the electric firefighting robotic vehicle further includes an electrical subsystem constructed and arranged to deliver electric power from the set of batteries to the first and second electric traction motors.

In some arrangements, the electrical subsystem includes a power bus and a set of battery interfaces coupled with the power bus. The set of battery interfaces is constructed and arranged to physically and electrically blind mate with the set of batteries when the set of batteries are received through the set of slot openings and into the set of hot-swappable slots defined by the battery chassis.

In some arrangements, the battery chassis defines a left hot-swappable slot adjacent the left side of the vehicle, and a right hot-swappable slot adjacent the right side of the vehicle. Additionally, the set of battery interfaces includes a left battery interface disposed within the left hot-swappable slot and a right battery interface disposed within the right hot-swappable slot. Furthermore, the left battery interface and the right battery interface have a uniform geometry enabling any battery of the set of batteries to physically and electrically blind mate with either the left battery interface or the right battery interface.

In accordance with certain embodiments, such a robotic firefighting vehicle includes an electric drivetrain having a set of electric motors enclosed within a chassis. The set of motors is disposed on left and/or right sides of the chassis and is configured to drive left and/or right drive wheels of the vehicle. A set of fluid conduits, such as one or more pipes, is disposed centrally within the chassis, between the left and right sides, and extends from a rear of the chassis to a front of the chassis. The set of fluid conduits may include a single conduit or multiple conduits, which may be stacked vertically and/or arranged side-by-side. A set of fluid couplings at the rear of the chassis allows for attachment of hoses or the like for delivering firefighting fluid, such as water, gel, or foam, to the set of conduits from an environment outside of the vehicle. A monitor at a front of the chassis is coupled to the set of conduits for receiving the firefighting fluid conducted through the set of conduits and for emitting the firefighting fluid toward desired locations in the environment.

Other embodiments are directed to systems, sub-systems, apparatus, assemblies, componentry, and so on. Some embodiments are directed to various methods, devices, platforms, etc. which are involved in utilizing a hot-swap battery system in an electric firefighting robotic vehicle.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of an electric firefighting robotic vehicle having a hot-swap battery system in accordance with certain embodiments.

FIG. 2 is a perspective top view of the electric firefighting robotic vehicle showing certain internal componentry in accordance with certain embodiments.

FIG. 3 is a perspective rear view of the electric firefighting robotic vehicle with a door opened from a first hinged side in accordance with certain embodiments.

FIG. 4 is a perspective rear view of the electric firefighting robotic vehicle with a battery partly extending from a slot while the door is opened in accordance with certain embodiments.

FIG. 5 is a perspective rear view of the electric firefighting robotic vehicle with the door opened from a second hinged side and another battery partly extending from another slot in accordance with certain embodiments.

FIG. 6 is an exploded rear view of the electric firefighting robotic vehicle in accordance with certain embodiments.

FIG. 7 is a perspective view of a first example battery suitable for use in the electric firefighting robotic vehicle in accordance with certain embodiments.

FIG. 8 is a perspective view of a second example battery suitable for use in the electric firefighting robotic vehicle in accordance with certain embodiments.

FIG. 9 is a perspective view of a portion of a battery chassis of the hot-swap battery system in accordance with certain embodiments.

FIG. 10 is a perspective view of a portion of a battery chassis provisioned with trays in accordance with certain embodiments.

FIG. 11 is a perspective view of the portion of the battery chassis further including batteries in accordance with certain embodiments.

FIG. 12 is a flowchart of a hot-swap battery procedure which is performed on the electric firefighting robotic vehicle in accordance with certain embodiments.

### DETAILED DESCRIPTION

An improved technique involves an electric firefighting robotic vehicle provisioned with a hot-swap battery system. Along these lines, such a hot-swap battery system allows a set of batteries having states of charge that have dropped to low states to be quickly and easily replaced with a set of charged batteries (e.g., by pulling spent batteries out of slots at the rears of the vehicles and inserting fully charged batteries into the slots in their place). Such replacement may be performed in the field to extend use time for as long as charged batteries are on hand. Accordingly, there is no need to wait for discharged batteries to be recharged. Moreover, in contrast to combustion-based firefighting robotic vehicles, there is no need to refill vehicle fuel tanks or deal with the various risks associated with locating and/or handling volatile/combustible fuels such as gasoline and diesel in dangerous environments.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

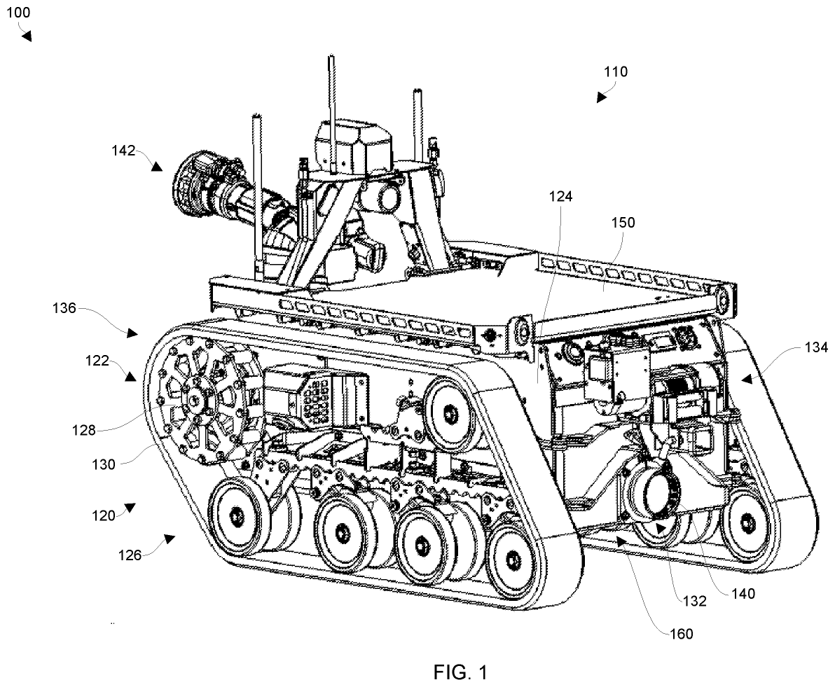

FIG. 1 shows a rear perspective view 100 of an example electric firefighting robotic vehicle 110 in accordance with certain embodiments. The example electric firefighting vehicle 110 is constructed and arranged to connect to a set of fluid sources (e.g., by connecting to one or more hoses leading to the set of fluid sources), move over a ground surface based on remote commands (e.g., in response to wireless signals from a base station), and deploy fluid from the set of fluid sources toward a target (e.g., spray the fluid onto a burning structure).

Along these lines, the electric firefighting robotic vehicle 110 includes an electric drivetrain 120 having a set of electric motors 122 supported by a vehicle chassis 124. The set of motors 122 may be disposed on left and/or right sides 126 of the chassis 124 and is configured to drive left and/or right drive wheels 128 of the vehicle 110. Such drive wheels 128 may in turn operate ground engaging members 130 (e.g., tracks, tires, combinations thereof, etc.) to enable the vehicle 110 to easily traverse a variety of different terrains which may be smooth, rough, hilly, uneven, irregular, etc. (e.g., roads, fields, sand, hills, ditches, rocky areas, creeks, uneven slopes, combinations thereof, and so on).

As shown in FIG. 1, the vehicle 110 further includes a set of fluid conduits 132, such as one or more pipes, which is disposed centrally within the chassis 124, between the left and right sides 126, and extends from a rear 134 of the chassis 124 to a front 136 of the chassis 124. The set of fluid conduits 132 may include a single conduit or multiple conduits, which may be stacked vertically and/or arranged side-by-side. A set of fluid couplings 140 at the rear of the chassis 124 allows for attachment of hoses or the like for delivering firefighting fluid, such as water, gel, or foam, to the set of conduits 132 from an environment outside of the vehicle 110. A monitor 142 at the front 136 of the chassis 124 is coupled to the set of conduits 132 for receiving the firefighting fluid conducted through the set of conduits 132 and for emitting the firefighting fluid toward desired locations in the environment.

It should be understood that the chassis 124 of the vehicle 110 may provide certain other features in addition to supporting componentry such as the electric drivetrain 120, the set of fluid conduits 132, the monitor 142, and so on. Along these lines, the vehicle 110 may include a deck section 150 and serve as a platform for performing various operations such as supporting specialized sensing equipment, carrying a tank that holds foam concentrate (e.g., for mixing with water before spraying), supporting a fan, supporting an array of lights and/or other equipment, carrying cargo, combinations thereof, etc.

As will be described in further detail shortly, the electric firefighting robotic vehicle 110 includes a hot-swap battery system 160 which is constructed and arranged to manage hot-swappable batteries. Along these lines, the hot-swap battery system 160 enables one or more original hot-swappable batteries to be quickly replaced with one or more new hot-swappable batteries (e.g., by pulling spent batteries out of slots at the rears of the vehicle 110 and inserting fully charged batteries into the slots in their place). Such replacement may be performed in the field to extend vehicle use time for as long as charged batteries are on hand.

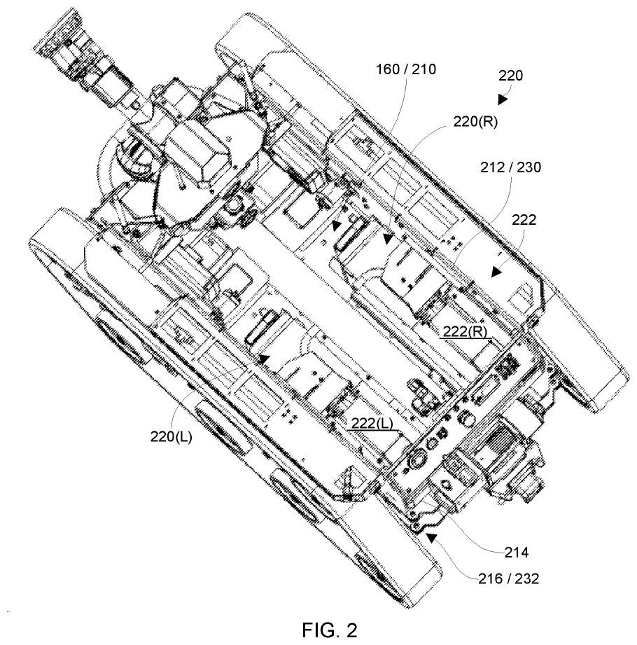

It should be appreciated that hot-swappable refers to ease and quickness that batteries may be uninstalled and replaced (e.g., simply pulling the batteries out of their slots and inserting new batteries in their place). In some situation, while one battery is being replaced, another battery remains in place and continues to provide electric power thereby enabling various electronics (e.g., operating circuitry) to remain in operation in a continuous, ongoing manner. Further details will now be provided with reference to FIGS. 2 through 6.

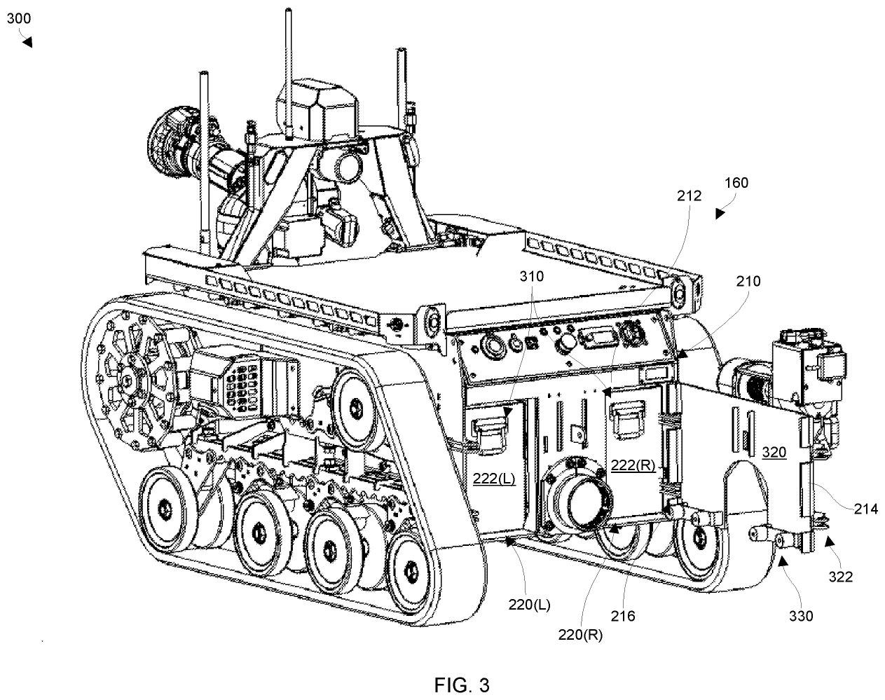

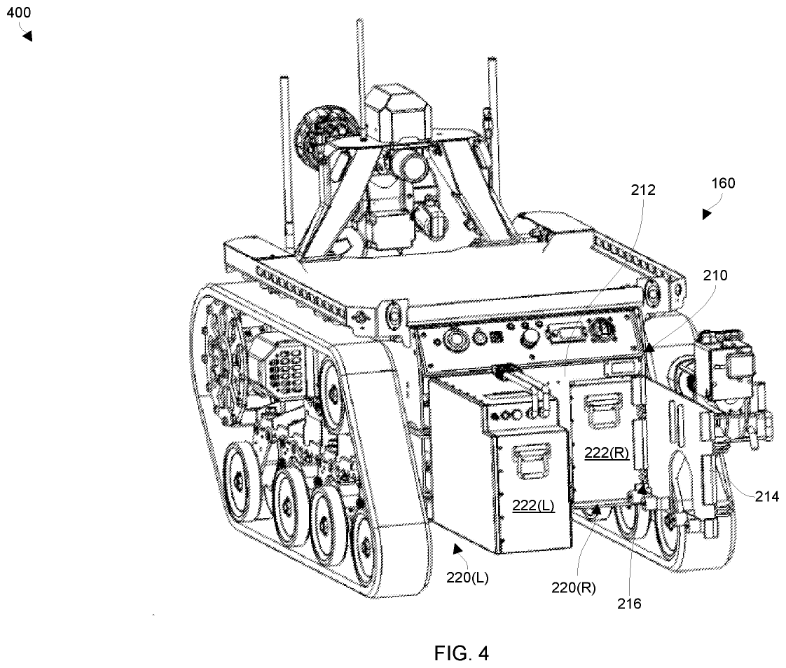

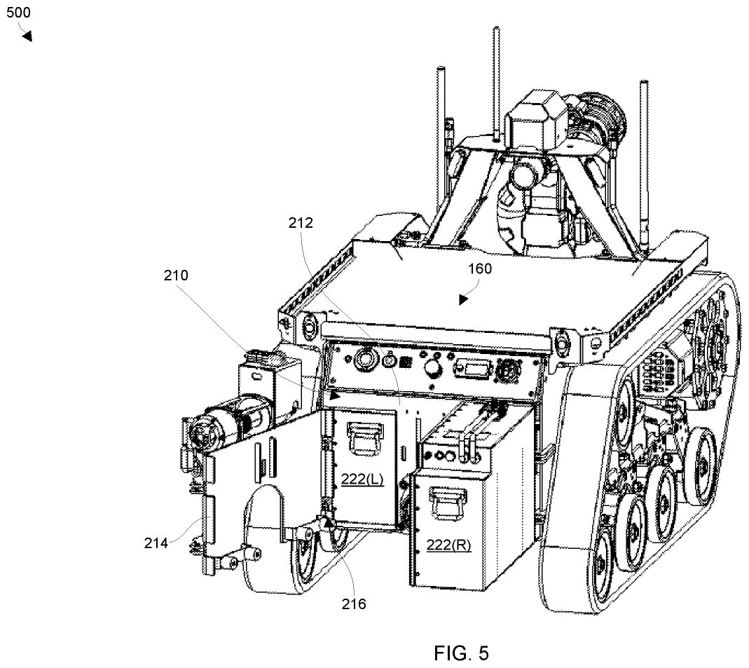

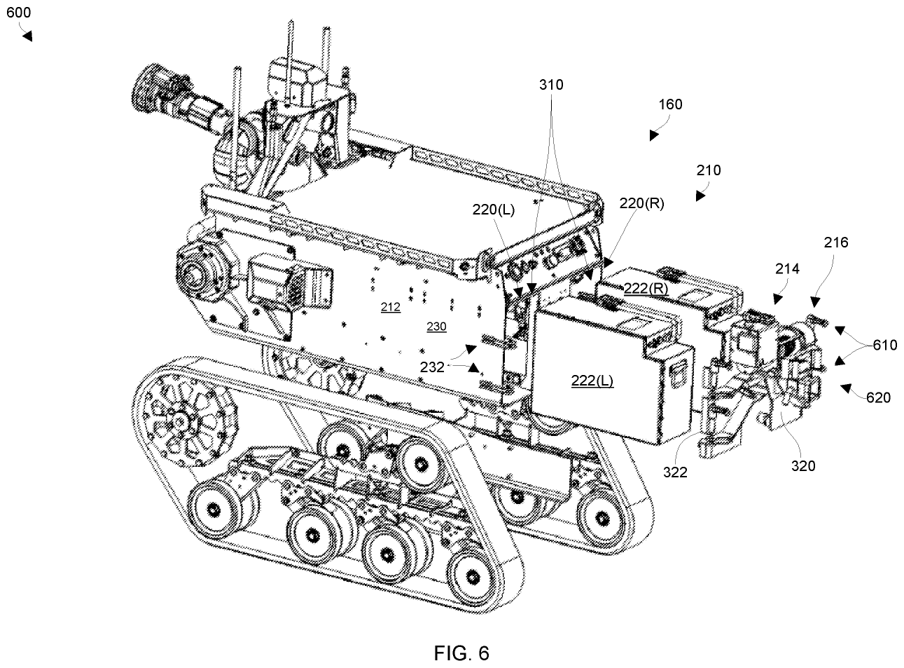

FIGS. 2 through 6 show further details of the example electric firefighting robotic vehicle 110 in accordance with certain embodiments. FIG. 2 is a perspective top view 200 showing certain internal componentry in accordance with certain embodiments. FIG. 3 is a perspective rear view 300 in accordance with certain embodiments. FIG. 4 is another perspective rear view 400 in accordance with certain embodiments. FIG. 5 is yet another perspective rear view 500 in accordance with certain embodiments. FIG. 6 is an exploded view 600 in accordance with certain embodiments.

As shown in FIGS. 2 through 6, the hot-swap battery system 160 includes a battery assembly 210 having a battery chassis 212, a door 214, and hardware 216. It should be understood that, in the perspective top view 200 of FIG. 2, the deck section 150 of the vehicle 110 (also see FIG. 1) has been removed to show certain hot-swap battery system details.

The battery chassis 212 is a support structure that defines a set of hot-swappable slots 220(L), 220(R) (collectively, slots 220) to house a set of batteries 222(L), 222(R) (collectively, batteries 222) which stores electric power to operate the set of electric motors 122. To this end, the battery chassis 212 is supported by or forms a portion of a frame of the vehicle 110. Along these lines, the battery chassis 212 may be supported by the overall chassis 126, may be integrated with the overall chassis 126, may mount to a frame of the vehicle 110, may derive support from a suspension of the vehicle 110, and so on.

The door 214 is constructed and arranged to reside within a closed state (FIGS. 1 and 2) or within an opened state (FIGS. 3 through 5). While the door 214 is in the closed state, the door 214 covers (i) a set of slot openings 310 (FIGS. 3 and 6) to the set of hot swappable slots 220 defined by the battery chassis 212 and (ii) the set of batteries 222 when the set of batteries 222 is housed within the set of hot-swappable slots 220. On the other hand, while the door 214 is in an opened state, the set of batteries 222 are available for replacement in a hot-swappable manner.

The hardware 216 is constructed and arranged to couple the door 214 with the battery chassis 212. As will be explained in further detail, the hardware 216 includes pins, some of which when removed enable the door 214 to swing outwardly in a certain direction from the battery chassis 212 to permit battery hot-swapping.

As best seen in FIGS. 2 and 6, the battery chassis 212 includes a set of chassis walls 230 defining the set of hot-swappable slots 220 and a set of chassis hinge portions 232 coupled with the set of chassis walls 230. In some arrangements, a first set of chassis hinge portions 232 resides along a left wall 230 of the battery chassis 212 and a second set of chassis hinge portions 232 resides along a right wall 230 of the battery chassis 212. Suitable geometries for the chassis hinge portions 232 include barrel-shaped hinge knuckles, loops, tabs, and the like.

The left wall 230 and a center wall 230 define the hot-swappable slot 220(L). Similarly, the right wall 230 and the center wall 230 define the hot-swappable slot 220(R). In some arrangements, the center wall 230 shields internal componentry disposed within the battery chassis 212 (e.g., plumbing, cabling, etc.).

In some arrangements, the door 214 includes a set of bumpers 330 disposed on an inner side of the cover portion 320 (i.e., the side facing the battery chassis 212, also see FIG. 3). The set of bumpers 330 are configured to compress (e.g., against the set of batteries 222, against the battery chassis 212, combinations thereof, etc.). Suitable materials for the set of bumpers 330 include rubber or similar compressible material, ultra-high molecular weight polyethylene (UHMW), and the like.

It should be understood that the set of bumpers 330 are positioned along a bottom edge the inner side of the cover portion 320 by way of example only. Other locations are suitable for use such as along a top edge, in the middle, combinations thereof, and so on. In some arrangements, the set of batteries 222 include a set of bumpers 330.

Accordingly, the set of bumpers 330 is able to provide stability to the door and/or the set of batteries 222. For example, by compressing against the set of batteries 222 while the door 214 is closed, the set of bumpers 330 inhibit movement of the set of batteries 222 while the batteries 222 are housed within the set of hot-swappable slots 220 and remain electrically connected with the vehicle 110 to prevent disconnection. Additionally, the door 220 will not cause damage to the set of batteries 222 if the door 214 is quickly closed (e.g., slammed shut while one or more batteries 222 is not fully installed into a respective hot-swappable slot 220, etc.

Also, as best seen in FIGS. 3 and 6, the door 214 includes a cover portion 320 and a set of door hinge portions 322 disposed around a periphery of the cover portion 310. In some arrangements, a first set of door hinge portions 322 resides along a left side of the door 214 and a second set of door hinge portions 322 resides along a right side of the door 214. Suitable geometries for the door hinge portions 322 include barrel-shaped hinge knuckles, loops, tabs, and the like.

Furthermore, as best seen in FIG. 6, the hardware 216 includes a set of pins 610 constructed and arranged to couple the set of door hinge portions 322 with the set of chassis hinge portions 232. Along these lines, the pins 610 are able to engage pairs of door hinge portions 322 with corresponding chassis hinge portions 232 to form operable hinges.

In accordance with certain embodiments, the set of pins 610 are hand-removable after the set of pins 610 is fully installed. Along these lines, a human operator is able to simply slide the set of pins 610 by hand from (or out of) their installed positions and/or back into their installed positions. In some arrangements, the pins are L-shaped metal rods which provide strength, ease for manual gripping (e.g., pushing into place, pulling to de-install, etc.), and effective hinge operation while installed.

When all pins 610 of the set of pins 610 couple the set of door hinge portions 322 with the set of chassis hinge portions 232, the set of pins 610 maintain the door 214 in a closed state against the battery chassis 212 (e.g., see FIG. 2). In this situation, the door 214 provides protection to the set of batteries 222 housed within the set of slots 220 and other internal componentry. Moreover, the set of batteries 222 remain richly and robustly connected with the vehicle 110 to supply electric power.

In a different situation, certain pins 610 of the set of pins 610 may couple the door hinge portions 322 on the right side of the cover portion 320 with chassis hinge portions 232 on the right side of the battery chassis 212. Here, other pins 610 of the set of pins 610 do not couple the door hinge portions 322 on the left side of the cover portion 320 with chassis hinge portions 232 on the left side of the battery chassis 212 (e.g., the pins 610 on the left side are manually removed). Now, the door 214 is in a first pivoting state relative to the battery chassis 212 in which the door 214 is hinged to the battery chassis 212 along the right side and is able to swing outwardly from the battery chassis 212 (e.g., see FIG. 3). While the door 214 is in this opened condition, one or more of the batteries 222 may be hot-swapped (e.g., see FIG. 4).

In yet another situation, certain pins 610 of the set of pins 610 may couple the door hinge portions 322 on the left side of the cover portion 320 with chassis hinge portions 232 on the left side of the battery chassis 212. Here, other pins 610 of the set of pins 610 do not couple the door hinge portions 322 on the right side of the cover portion 320 with chassis hinge portions 232 on the right side of the battery chassis 212 (e.g., the pins 610 on the right side are manually removed). Now, the door 214 is in a second pivoting state relative to the battery chassis 212 in which the door 214 is hinged to the battery chassis 212 along the left side and is able to swing outwardly from the battery chassis 212 (e.g., see FIG. 5). In this opened condition, one or more of the batteries 222 may be similarly hot-swapped.

Moreover, when none of the pins 610 of the set of pins 610 couple the door hinge portions 322 with chassis hinge portions 232, the door 214 is no longer attached to the battery chassis 212. Such a situation enables the door to 214 to be removed leaving the entire the battery chassis 212 open for access (e.g., see FIG. 6).

In accordance with certain embodiments, the electric firefighting robotic vehicle 110 further includes an accessory 620 (FIG. 6) coupled with the door 214. For example, the accessory may be a winch mounted to an outer side of the cover portion 320 of the door 214. Such a winch may enable winding and unwinding of a cable (e.g., to pull/tow objects, etc.).

In some arrangements, the cover portion 320 of the door 214 and the center (or middle) wall 230 of the battery chassis 212 may include features (e.g., one or more tabs, tab slots, hooks, etc.) which enable the door 214 to further fasten to the battery chassis 212 for added strength. For example, the center wall 230 may define a loop which passes through a tab slot in the middle of the door 214 (FIG. 3) to enable fastening (e.g., via a pin or other fastener) for added rigidity to support the accessory 620 (FIG. 6).

It should be understood that the batteries 222 may be provided as battery modules (or packages), e.g., casings containing arrays of individual cells connected together. Such casings may further contain circuitry (e.g., voltage sensors, current sensors, temperature sensors, battery management system circuitry, combinations thereof, etc.).

In some arrangements and as best seen in FIG. 6, the casings for the batteries 222 may be relatively solid (e.g., free of openings) to protect componentry within the casings (e.g., against dust, dirt, liquids, etc.). Nevertheless, casings may have additional features such as front handles to assist with de-installation from the hot-swappable slots 220, appropriately positioned connectors to enable blind-mating, front-positioned circuitry (e.g., connectors, gauges, etc.) for accessing and/or controlling the batteries 222, and so on.

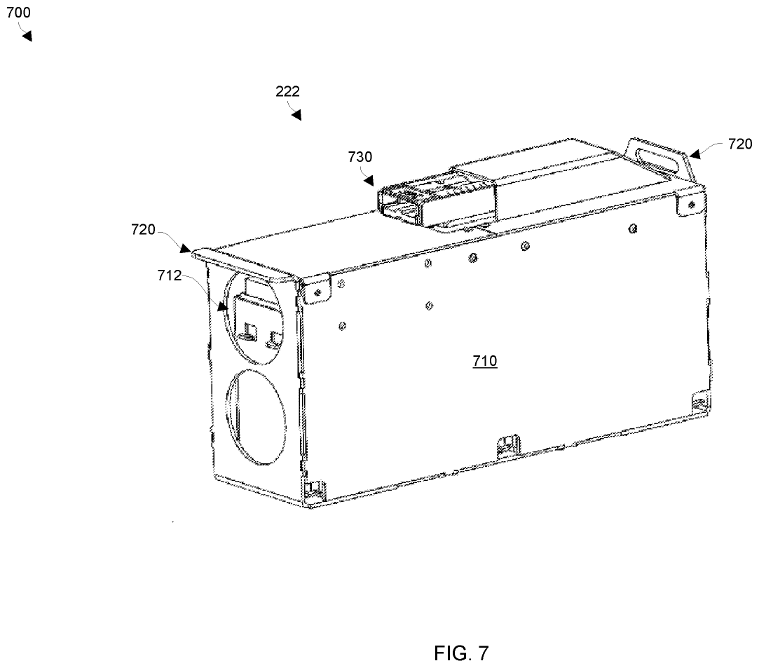

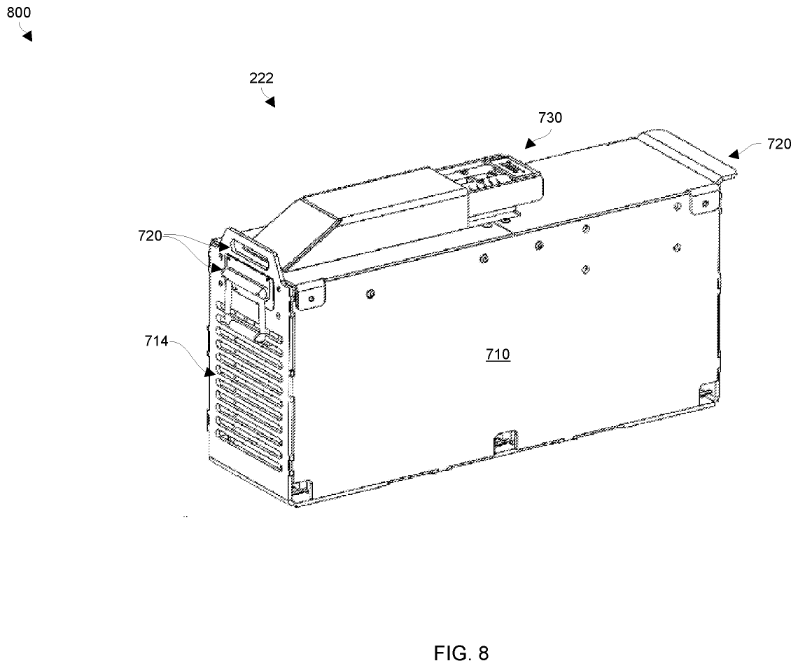

FIGS. 7 and 8 show views of an alternative battery configuration for a battery 222 in accordance with certain embodiments. FIG. 7 shows a perspective rear view 700. FIG. 8 shows a perspective front view 800.

In accordance with the alternative battery configuration, an outer casing 710 has or defines features such as rear openings (or ducts) 712 and front vents 714 for airflow (e.g., from a set of fans within the battery chassis 212), handles 720 to enable holding and/or maneuvering of the battery 222, and so on.

As also shown in FIGS. 7 and 8, the battery 222 includes an external electrical interface 730 for delivering electric power to the electric firefighting robotic vehicle 110. The external electrical interface 730 is disposed on a top of the casing 710 and faces toward the rear of the battery 222(into the slot 220 during hot-swapping) to enable the external electrical interface 730 to engage with and disengage from a corresponding connector of the vehicle 110 which is recessed within a hot-swappable slot 220. Such features enable the battery 222 to automatically connect with the vehicle 110 in blind-mating manner. That is, a user does not need to directly handle connectors to electrically connect the battery 222 with the vehicle 110. Instead, the user may simply push the battery 222 fully into a hot-swappable slot 220 and the interfaces will automatically engage to electrically connect the battery 222 with the vehicle 110. Additionally, the user may simply pull the battery 222 out of the hot-swappable slot 220 to electrically disconnect the battery 222 from the vehicle 110.

In some arrangements, the external electrical interface 730 simply includes power terminals for connecting to a power bus of the vehicle 110. Such arrangements enable a user to then connect a separate connector (e.g., at the end of a cable) to a different connector (e.g., at the front of the battery 222) to access the battery 222 via a user interface (e.g., a control panel of the vehicle 110).

In other arrangements, the external electrical interface 730 further includes control/status connections. Such arrangements enable all connectors for the battery 222 to be made by pushing the battery 222 fully into the hot-swappable slot 220, etc. (the user does not need to handle any connectors directly).

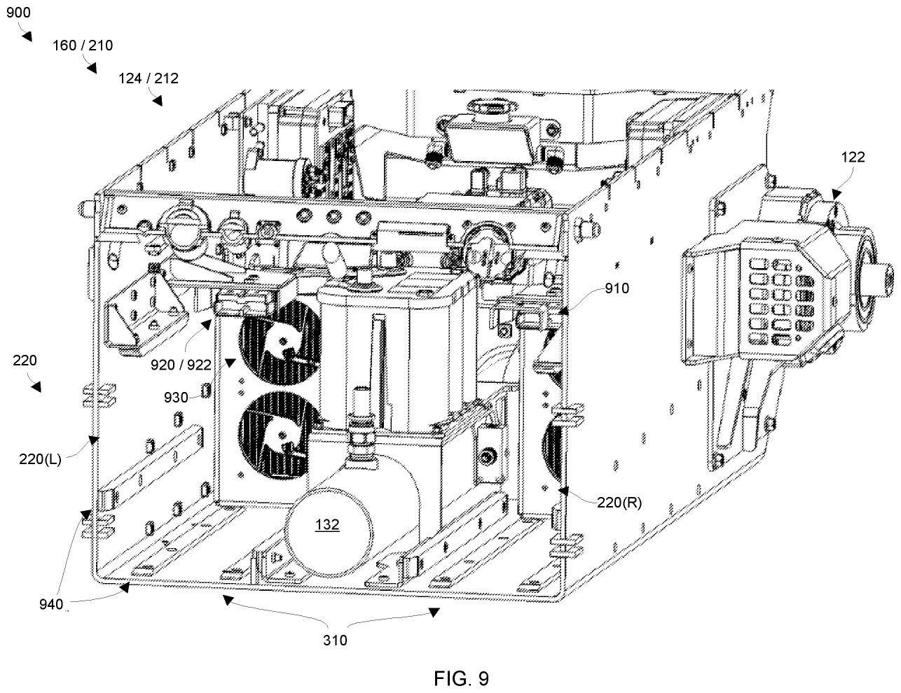

FIG. 9 shows a view 900 of at least a portion of the battery assembly 210 of the hot-swap battery system 160 in accordance with certain embodiments. As shown in the view 900, the battery chassis 212 is integrated with the vehicle chassis 124 (also see FIG. 1) which supports the set of electric traction motors 122 (e.g., a left electric traction motor 122 on a left side and a right electric traction motor 122 on a right side).

As shown in FIG. 9, the chassis 124 of the electric firefighting robotic vehicle 110 includes an electrical subsystem 910 constructed and arranged to deliver electric power from the set of batteries 222(FIGS. 2 through 6) to the set of motors 122. Along these lines the electrical subsystem 910 includes a power bus 920 and a set of battery interfaces 922 coupled with the power bus 920. That is, the power bus 920 and the set of battery interfaces 922 form part of the vehicle's electrical subsystem.

In some arrangements, the set of battery interfaces 922 is constructed and arranged to physically and electrically blind mate with the set of batteries 222 when the set of batteries 222 is received through the set of slot openings 310 and into the set of hot-swappable slots 220 defined by the battery chassis 214. Accordingly, a user does not need to directly handle connectors, power terminals, etc. that may carry high current.

In some arrangements, the set of hot-swappable slots 220(L), 220(R) are uniform in geometry to enable any battery 222 of the set of batteries 222 to physically and electrically blind mate with the battery interface 922 disposed in either slot 220(L), 220(R). Moreover, other batteries 222 may be on hand which are able to physically and electrically blind mate into either slot 220(L), 220(R) as well so that the batteries 222 can be quickly replaced to maintain vehicle operation.

As further shown in FIG. 9, there may be other componentry available within the set of hot-swappable slots 220. For example, in some arrangements, the hot-swap battery system 160 further includes fans 930 constructed and arranged to circulate air through the batteries 222(e.g., also see the openings 712 in FIG. 7). Additionally, in some arrangements, the batteries 222 are positioned within the slots 220 to be in thermal communication with the set of fluid conduits 132 (also see FIG. 1) for enhanced cooling. Furthermore, in some arrangements, the inner sides (or walls) that define the slots 220 support a set of guides 940 (e.g., UHMW rails) to assist in properly positioning the batteries 222 within the slots 220(e.g., to facilitate interface alignment for blind mating). Other componentry may be disposed within or be accessible via the slots 220 as well.

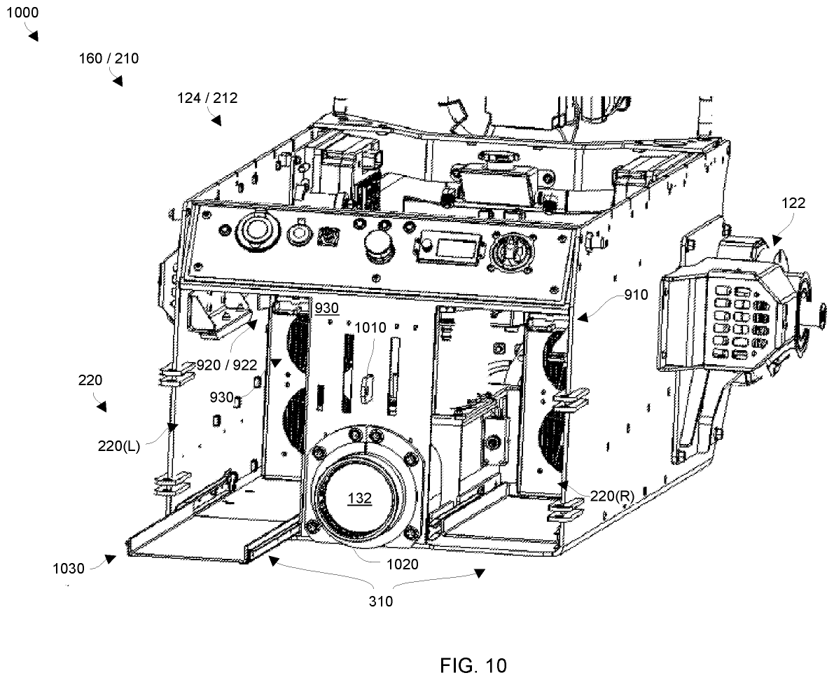

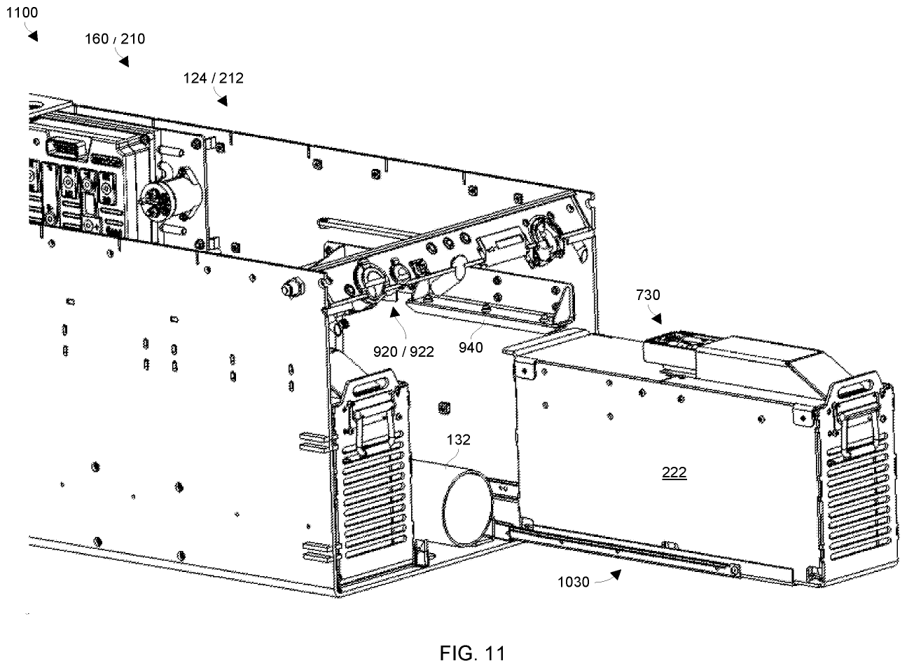

FIGS. 10 and 11 show at least a portion of the battery assembly 210 of the hot-swap battery system 160 in accordance with certain embodiments. FIG. 10 shows a view 1000 without batteries 222. FIG. 11 shows a view 1100 with batteries 222.

In the view 1000, the central wall 930 is shown to better illustrate certain central wall features such as providing a tab 1010 which enables the door 212 to be secured to the central wall 930 for added door rigidity, providing a surface to support mounting (or coupling) hardware 1020 for connecting one or more fluid sources, and so on. However, in the view 1100, the center wall 930 is again removed to illustrate other details.

As shown in FIGS. 10 and 11, the battery chassis 212 may include a set of trays 1030 which can slide into and out of the set of hot-swappable slots 220. The trays 1030 may include platform sections and sliding arms (or roller arms) to facilitate tray operation (e.g., to extend the trays 1030 out of the slots 220 and/or to withdraw the trays 1030 into the slots 220). Accordingly, less effort is required to install and/or remove the batteries 222 during hot-swapping.

Along these lines and as best seen in FIG. 11, a battery 222 may be de-installed by simply sliding the battery 222 out of the battery chassis 212 while the battery 222 sits on a tray 1030. Once the battery 222 exits the battery chassis 212, the battery 222 may be lifted off the tray 1030 and replaced with another battery 222.

Similarly, once a battery 222 is placed on a tray 1030 that extends out of the battery chassis 212, the battery 22 is ready for connection. Along these lines, the battery 222 is simply slid into the battery chassis 212 while the battery remains sitting on the tray 1030 until the battery 222 connects with the electrical subsystem of the vehicle 110 (e.g., via blind mating).

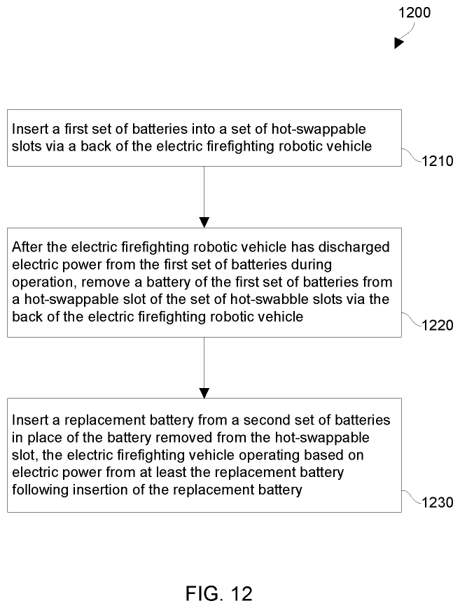

It should be appreciated that, during installation and/or de-installation of a battery 222, the trays 222 and/or guides 940 control alignment of the battery interface 730 with the interface 922 of the vehicle 110 for reliable operation and to prevent interface damage. Further details will now be provided with reference to FIG. 12.

FIG. 12 is a flowchart of a hot-swap battery procedure 1200 which is performed on an electric firefighting robotic vehicle in accordance with certain embodiments. Such a procedure 1200 enables the vehicle to continue operation without significant interruption as long as charged batteries are on hand.

1210 involves inserting a first set of batteries into a set of hot-swappable slots via a back of the electric firefighting robotic vehicle. Once the first set of batteries is inserted, the first set of batteries is able to provide electric power to the vehicle (e.g., for electric propulsion).

1220 then involves, after the electric firefighting robotic vehicle has discharged electric power from the first set of batteries during firefighting robotic vehicle operation, removing a battery of the first set of batteries from a hot-swappable slot of the set of hot-swappable slots via a back of the electric firefighting robotic vehicle. For example, the vehicle may have maneuvered over terrain while delivering fluid to a burning target to extinguish the fire. The vehicle may have then moved away from the burning target to a safe location to undergo battery hot-swapping.

1230 then involves inserting a replacement battery from a second set of batteries in place of the battery removed from a hot-swappable slot, the electric firefighting robotic vehicle operating based on electric power from at least the replacement battery following insertion of the replacement battery. The replacement battery may be fully charged so that once the replacement battery is in place, the vehicle has access to more charge.

It should be appreciated that the above-mentioned activities may be performed again. Along these lines, while the replacement battery from the second set of batteries remains inserted in place of the battery removed from the hot-swappable slot, another battery of the first set of batteries may be removed from another hot-swappable slot of the set of hot-swappable slots via the back of the electric firefighting robotic vehicle (see 1220 in FIG. 12). Then, another replacement battery from the second set of batteries may be inserted in place of the other battery removed from the other hot-swappable slot (see 1230 in FIG. 12).

Next, the electric firefighting robotic vehicle may return to the burning target to continue delivery of the fluid over the target. As long as batteries 222 are on hand, the entire procedure 1200 may be repeated. Moreover, while one set of batteries is being used by the vehicle, it should be appreciated that another set of batteries may be charged from a power source.

As described above, improved techniques involve electric firefighting robotic vehicles 110 provisioned with hot-swap battery systems 160. Along these lines, such hot-swap battery systems 160 allow batteries 222 having states of charge that have dropped to low states to be quickly and easily replaced with charged batteries 222(e.g., by pulling spent batteries 222 out of slots at the rears of the vehicles 110 and inserting fully charged batteries 222 into the slots in their place). Such replacement may be performed in the field to extend use time for as long as charged batteries 222 are on hand. Accordingly, there is no need to wait for discharged batteries 222 to be recharged. Moreover, in contrast to combustion-based firefighting robotic vehicles, there is no need to refill vehicle fuel tanks or deal with the various risks associated with locating and/or handling volatile/combustible fuels such as gasoline and diesel in dangerous environments.

It should appreciated that the above-depicted features of the hot-swap system can be used in a variety of different embodiments individually or in combination. Moreover, the embodiments are not limited to the above-described robotic vehicle.

It should be further appreciated that the above-described robotic vehicle is a multifunctional firefighting tool that is meant to enhance and diversify the resources available to a firefighter in accordance with certain embodiments. Now with the addition of a hot-swappable battery system, it can further its capabilities for firefighters by extending its use time for as long as the operator has charged batteries on hand. With other robots, having a fuel source to refill the robot was all it took to get extended hours, electric robots present a problem in this regard as they take a lot longer to charge than is feasible to do in the field. With the battery system features described herein an operator can now have charged batteries staged, ready to go, and once he sees his state of charge dropping to a low state, he can quickly open the back of the robot and replace the discharged (e.g., depleted or dead) batteries with fresh ones and get back to the task at hand.

In conjunction with/as a result of the hot swap battery configuration many other vehicle changes can be made in accordance with certain embodiments. Along these lines, the chassis may be lengthened (e.g., 2 inches), longer vehicle tracks may be selected, new suspension carriers may be utilized, chassis modifications to be able to accept a larger manifold (e.g., 4 inches), a removable rear door for battery access may be provided, a new top deck may be utilized, relocation of vehicle rear facing strobes and scene lighting may be provided. Other features may be provided as well such as a new battery charging system which also enables a new electronics bay layout, new battery packs, new low voltage battery mounts, more vehicle protection sprayers and 360 camera system integration, and so on.

In accordance with certain embodiments, starting with a safely parked vehicle, with power off, pulling two pins on either one side or the other of the battery access door and one central pin allows the door to swing open (removing all allows the door to be removed completely), giving the operator access to the battery compartment. The battery management system (BMS) needs to be disconnected from the battery pack's exposed face, then by pulling on the grab handle on the battery and pulling the battery rearward out of the vehicle it will disconnect itself from the power system of the robot as well as separating from the cooling system.

The battery then slides out of the vehicle being guided by UHMW plastic slides that operate in the function of guiding the battery to and from the power connection in the forward part of the robot as well as acting as the restraining system for the batteries. Once out the battery can be replaced following the above in reverse, with the bumpers on the door acting as the final restraint keeping the batteries secured.

In some embodiments, there are two hot-swappable battery modules, left and right (e.g., see FIG. 2). A rear door can swing closed to cover the battery modules (FIG. 2), or can swing open to expose them, e.g., as needed for replacement (FIGS. 4 and 5).

In some embodiments, the door is hinged on both sides (FIGS. 4 and 5), via hinges on the chassis and hinges on the door. The door can swing open in either direction. For example, pins may be inserted through holes in the hinges on both left and right sides to secure the door closed (FIG. 1). Removing pins in either side allows the door to open about the hinges on the opposite side (FIGS. 4 and 5).

Rubber bumpers hold the battery modules fully seated when the door is closed and secured (FIG. 3). Accordingly, the battery modules do not inadvertently disconnect from the vehicle.

In accordance with certain embodiments, the battery modules have grab handles. Accordingly, the handles may be pulled to withdraw the battery modules from inside of the chassis.

In accordance with certain embodiments, a mount holds the large electrical connector for receiving battery power. Guides align the battery module and restrain the battery module while the vehicle is in operation. In an example, the battery module makes a blind-mate electrical connection when inserted along the guides. Pulling on the grab handle disconnects the blind-mate electrical connection.

In some examples, the chassis has a floor, and the set of conduits runs between the front and back of the chassis along the floor.

In some examples, the floor includes perforations that enable any fluid within the chassis to be drained. In other examples, the chassis is fluid tight and prevents intrusion of water or other fluid into an interior of the chassis.

In some examples, the set of conduits is mechanically coupled to the chassis using suspension, such as rings and/or cradles that provide cushioning, so as to reduce conduction of vibration between the set of conduits and the chassis.

In some examples, the set of conduits is mechanically coupled to the set of fluid couplings and/or to the monitor using rings and/or cradles that provide cushioning.

In some examples, the vehicle further includes an electronically controllable butterfly valve connected in-line with the monitor for controlling the flow of fluid to the monitor, such as turning the flow of fluid on and off.

In some examples, the set of electric motors includes a left motor disposed on the left side of the chassis and a right motor disposed on the right side of the chassis. The left motor is coupled to the left drive wheel and the right motor is coupled to the right drive wheel.

In some examples, the left drive wheel is a left drive sprocket of a left track assembly, and the left motor is constructed and arranged to drive a track of the left track assembly forward and/or backward via the left drive sprocket.

In some examples, the right drive wheel is a right drive sprocket of a right track assembly, and the left motor is constructed and arranged to drive a track of the right track assembly forward and/or backward via the right drive sprocket.

In some examples, each drive sprocket has an axle and the respective motor is oriented within the chassis such that a motor shaft of the motor forms a 90-degree angle with the axle of the drive sprocket. A respective gearbox, provided within the chassis, translates rotation of the motor shaft into corresponding rotation of the drive sprocket.

In some examples, the left motor and gearbox are mounted to a plate on the left side of the chassis, and the motor, gearbox, and plate are removable as a unit through the left side of the chassis. Similarly, in some examples, the right motor and gearbox are mounted to a plate on the right side of the chassis, and the right motor, gearbox, and plate are removable as a unit through the right side of the chassis. Such side access avoids having to open the chassis to service the motors.

In some examples, a set of batteries is provided within the chassis for powering the set of motors. For example, a first battery module is provided for powering the left motor and a second battery module is provided for powering the right motor. According to some examples, the first battery module is disposed on the left side of the chassis and the second battery module is disposed on the right side of the chassis.

In some examples, the set of fluid conduits includes a single conduit. The left motor and the first battery module are disposed to the left of the conduit, and the right motor and second battery module are disposed to the right of the conduit.

In some examples, the vehicle includes a top deck attached to a top of the chassis. The top deck is substantially flat and provides a convenient surface for carrying equipment and/or personnel.

In some examples, the top deck or a portion thereof is removable, for example, in a manner that does not require tools.

In some examples, the floor of the chassis provides a first level at which components are housed, and the chassis further includes a second level disposed above the first level. The second level provides a convenient location for housing frequently serviceable items, such as relays, fuses, communication controllers, computer equipment, and the like, which may be used by the vehicle during its operation. Spare parts may also be stowed conveniently at the second level.

In some examples, the second level is accessed by removing the top deck, or a portion thereof, using a procedure that does not require tools. For example, the top deck or portion may be opened or removed using hand-operated clamps or latches.

In some examples, the second level of the chassis includes a base and a set of components mounted to the base. In some examples, the base of the second level is parallel to the floor of the chassis. Non-parallel arrangements may also be used, however.

In some examples, the base of the second level is provided as a removable tray. In some examples, the removable tray is configured to disengage from the chassis without the use of tools, e.g., by opening hand-operated clamps or latches, disconnecting one or more electrical cables, and/or the like.

In some examples, the vehicle further includes a U-shaped or V-shaped mast assembly that extends upwardly from the top deck of the vehicle near a front of the top deck. In some examples, the mast assembly provides protection for the monitor in the unlikely event of a vehicle rollover.

In some examples, the mast assembly includes left and right forward-projecting scene lights, configured to illuminate an area in front of the vehicle. The left scene light points forward and to the left, and the right scene light points forward and to the right.

In some examples, the mast assembly includes a set of cameras. At least some of the set of cameras may be attached at a level higher than the monitor, e.g., so that the monitor does not block their field(s) of view. The set of cameras may include an optical camera and/or an infrared camera, which can be especially effective in smoky environments. In some examples, the set of cameras may further include a rear-facing camera, which points toward the rear of the vehicle, and thus can be useful when driving the vehicle in reverse.

In some examples, the mast assembly includes a set of antennas. Such antennas may include one or more wireless antennas (e.g., Wi-Fi, Bluetooth, cellular, or satellite, for example), and one or more video antennas, for transmitting video.

In some examples, the vehicle includes a liquid spray system for cooling an exterior of the vehicle. For example, a pipe or tube may be tapped from the set of conduits (or a single conduit) for receiving charged (i.e., pressurized) fluid. The fluid may be distributed, via a system of tubes and nozzles, to various regions of the vehicle where fluid-based cooling and/or fire suppression is desired. For example, nozzles may be provided above the left and right tracks, at the front corners of the vehicle, and/or above the vehicle (e.g., from one or more nozzles mounted to the mast assembly), where the fluid can be sprayed over the front of the vehicle itself and/or over an area directly in front of the vehicle and/or to the sides and/or all around the vehicle. The liquid spray system helps to keep vehicle surfaces, and especially the tracks, cool enough to resist deformation or degradation that might otherwise occur in hot environments in which active fires may be present.

In some examples, the vehicle further includes a winch assembly. The winch assembly is configured to run from electrical power of the vehicle. The electrical power may be provided by the set of battery modules (i.e., the same ones that drive the motor(s)) and/or may be provided from a separate set of batteries, such as one or more 12-volt batteries. In some examples, the winch assembly receives electrical power via an electrical outlet provided at or near the rear of the chassis.

In some examples, the vehicle further includes a towing hitch coupled to the rear of the chassis. The towing hitch has a hollow region for accepting a receiver of equipment to be towed. In some examples, the winch assembly is mounted to an external surface of the towing hitch, rather than to the hollow region. The hollow region is thus left open and accessible, such that the towing hitch can be used at the same time both for towing equipment and for supporting the winch assembly. Also, mounting the winch assembly to an external surface (e.g., top) of the towing hitch enables the winch assembly to be mounted closer to the chassis than it would be if attached to the end of the towing hitch in the usual way, thus reducing turning moment and stress on components. In some examples, the winch assembly is coupled to the towing hitch via a connecting pin and cotter pin, such that it is easily removable from the vehicle.

In some examples, the vehicle further includes a modular, adjustable suspension carrier.

Certain embodiments are directed to a robotic firefighting vehicle. Further embodiments are directed to a method of cooling an exterior of a robotic firefighting vehicle. Still further embodiments are directed to a chassis of a robotic firefighting vehicle. Still further embodiments are directed to a suspension of a robotic firefighting vehicle. Still further embodiments are directed to a winch assembly of a robotic firefighting vehicle.

Additional embodiments are directed to a hot-swap battery system for electric firefighting robotic vehicle. However, in accordance with certain embodiments, the hot-swap battery system is used with other types of equipment (e.g., other types of robotics, other types of vehicles, machinery, electrical equipment, specialized apparatus, combinations thereof, etc.).

In accordance with certain embodiments, the disclosed electric firefighting robot is a multifunctional firefighting tool that enhances and diversifies the resources available to a firefighter. Such an embodiment may serve at least two main purposes, 1) to direct water from a charged hose via remote operated nozzle (or other material/fluid), and 2) provide a modular platform for outfitting gear, attachments, tools, and other relevant firefighting items. The remote operated nozzle allows the operator to fight a fire from a safe distance, as well as allow a greater water volume than a conventional hand line. The flat deck on top of the robot provides an area for additional payloads to be stored. Several other features on the robot provide additional tooling in the form of a winch, hitch, scene lighting, and cameras for situational awareness.

A steel chassis hull contains a fully electric drivetrain and battery bank for powering the vehicle. Bolted to the chassis hull is a track suspension system complete with drive sprockets, road wheels, and a tensioner wheel. The hull is covered by a flat deck panel that is removable without tools for access to the inside of the robot. The flat deck panel protects the inner components of the robot and provides a surface for additional payloads to be mounted or stored.

A mechanically isolated water passageway delivers water through the vehicle, starting from the rear of the robot where a charged hose is attached, and ending at a remotely operated water nozzle. The water can be stopped or started at the nozzle by operating an electric butterfly valve, allowing for charged water to be available immediately. The mechanical isolation of the water passageway may be a good design practice for a pressure vessel such as this, where hard mounts would create stress concentrations that would fatigue the vessel and chassis. These stress concentrations would be brought about by physical forces applied to the vessel (pulling the charged hose) as well as temperature fluctuations that expand and contract materials at different rates.

In accordance with certain embodiments, a receiver hitch located on the rear of the machine accepts a hitch for moving trailers. A removable winch pins to the outside of this receiver hitch, allowing for tool-less removal of the hitch as well as use of the receiver while the winch is installed. The winch plugs into a port in the back of the vehicle for power supply.

An elevated platform on top of the flat deck behind the water nozzle serves several purposes including a mount for antennas, visual cameras, infrared cameras, scene lights, and vehicle cooling sprayers. The platform is also a safety feature in the event of a rollover, decreasing the risk of damaging the robot, water nozzle, or personnel.

Water lines fed by the inlet of the water passageway run along the edges of the robot, expelling water from nozzles that keep the robot and suspension system cool. These lines continue up to the elevated platform to mist the vicinity of the robot for cooling in hot environments, allowing the robot to be as close to the flames as possible.

Further, although embodiments have been described that involve both left and right motors and respective battery modules, this arrangement is not required. For example, alternative arrangements may use a single motor, such as one connected to a differential that supplies power to both left and right drive wheels (e.g., tracks). Also, one should appreciate that any number of battery modules may be provided, including a single battery module, based on power demands on the vehicle and other factors. There is no necessary correspondence between motors and battery modules. For example, battery modules may be connected in parallel or grouped in any suitable way. A battery module on the left can connect to a motor on the right, and vice-versa.

Further, embodiments are not limited to delivering fluid. For example, embodiments may be directed to any of the features, apparatus, and/or methodology disclosed herein, whether directed to delivering fluid or to something else.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

While various embodiments of the present disclosure have been particularly shown and described, it will be understood by those skilled in the art that various changes in form and details may be made therein without departing from the spirit and scope of the present disclosure as defined by the appended claims. Such modifications and enhancements are intended to belong to various embodiments of the disclosure.

What is claimed is:

1. An electric firefighting robotic vehicle, comprising:
a vehicle frame constructed and arranged to support firefighting equipment;
a set of electric motors supported by the vehicle frame to provide firefighting robotic vehicle propulsion; and
a battery assembly constructed and arranged to provide electric power to the set of electric motors, the battery assembly including:
a battery chassis defining a set of hot-swappable slots to house a set of batteries which stores the electric power,
a door constructed and arranged to cover (i) a set of slot openings to the set of hot-swappable slots defined by the battery chassis and (ii) the set of batteries when the set of batteries is housed within the set of hot-swappable slots, and
hardware constructed and arranged to couple the door with the battery chassis.

2. The electric firefighting robotic vehicle of claim 1 wherein the battery chassis includes a set of chassis walls defining the set of hot-swappable slots and a set of chassis hinge portions coupled with the set of chassis walls;
wherein the door includes a cover portion and a set of door hinge portions disposed around a periphery of the cover portion; and
wherein the hardware includes a set of pins constructed and arranged to couple the set of door hinge portions with the set of chassis hinge portions.

3. The electric firefighting robotic vehicle of claim 2 wherein the set of pins is constructed and arranged to maintain the door in a closed state against the battery chassis when all pins of the set of pins couple the set of door hinge portions with the set of chassis hinge portions.

4. The electric firefighting robotic vehicle of claim 3 wherein the set of pins is constructed and arranged to maintain the door in a first pivoting state relative to the battery chassis when (i) first pins of the set of pins couple door hinge portions on a first side of the cover portion with chassis hinge portions on a first side of the battery chassis and (ii) second pins of the set of pins do not couple door hinge portions on a second side of the cover portion with chassis hinge portions on a second side of the battery chassis.

5. The electric firefighting robotic vehicle of claim 4 wherein the set of pins is constructed and arranged to maintain the door in a second pivoting state relative to the battery chassis when (i) the second pins of the set of pins couple the door hinge portions on the second side of the cover portion with the chassis hinge portions on the second side of the battery chassis and (ii) the first pins of the set of pins do not couple the door hinge portions on the first side of the cover portion with the chassis hinge portions on the first side of the battery chassis; and
wherein the second side of the cover portion is opposite the first side of the cover portion.

6. The electric firefighting robotic vehicle of claim 5 wherein the door is constructed and arranged to fully detach from the battery chassis when none of the set of pins couple the set of door hinge portions with the set of chassis hinge portions.

7. The electric firefighting robotic vehicle of claim 5 wherein the first pins and the second pins are hand-removable L-shaped metal rods.

8. The electric firefighting robotic vehicle of claim 3, further comprising:
a winch mounted to an outer side of the cover portion of the door, the winch being constructed and arranged to control winding and unwinding of a cable.

9. The electric firefighting robotic vehicle of claim 8 wherein the hardware further includes a hand-removable central fastener constructed and arranged to fasten a central section of the cover portion of the door to the battery chassis while the door is in the closed state against the battery chassis to add rigidity which supports the winch.

10. The electric firefighting robotic vehicle of claim 3 wherein the door further includes a set of bumpers disposed on an inner side of the cover portion, the set of bumpers being constructed and arranged to inhibit movement of the set of batteries within the battery chassis when the set of batteries is housed within the set of hot-swappable slots.

11. The electric firefighting robotic vehicle of claim 10 wherein the set of bumpers is constructed and arranged to compress between the cover portion and the set of batteries when the set of batteries is housed within the set of hot-swappable slots and the door is held in the closed state against the battery chassis.

12. The electric firefighting robotic vehicle of claim 3 wherein the battery chassis further includes:
a set of guides coupled with the set of chassis walls, the set of guides being constructed and arranged to align the set of batteries within the set of hot-swappable slots during insertion of the set of batteries into the set of hot-swappable slots.

13. The electric firefighting robotic vehicle of claim 3 wherein the set of chassis walls includes a left chassis wall, a center chassis wall, and a right chassis wall;
wherein the left chassis wall and the center chassis wall define a left hot-swappable slot;
wherein the right chassis wall and the center chassis wall define a right hot-swappable slot; and
wherein the set of guides includes a left set of ultra-high molecular weight polyethylene (UHMW) rails coupled with the left chassis wall to align a battery in the left hot-swappable slot, and a right set of UHMW rails coupled with the right chassis wall to align a battery in the right hot-swappable slot.

14. The electric firefighting robotic vehicle of claim 1 wherein the vehicle frame defines left side, a right side, a front and a back of the electric firefighting robotic vehicle;
wherein the set of electric motors includes a left electric traction motor that operates a left ground engaging member disposed on the left side of the vehicle, and a right electric traction motor that operates a right ground engaging member disposed on the right side of the vehicle; and
wherein the electric firefighting robotic vehicle further comprises:
an electrical subsystem constructed and arranged to deliver electric power from the set of batteries to the first and second electric traction motors.

15. The electric firefighting robotic vehicle of claim 14 wherein the electrical subsystem includes:
a power bus; and
a set of battery interfaces coupled with the power bus, the set of battery interfaces being constructed and arranged to physically and electrically blind mate with the set of batteries when the set of batteries are received through the set of slot openings and into the set of hot-swappable slots defined by the battery chassis.

16. The electric firefighting robotic vehicle of claim 15 wherein the battery chassis defines a left hot-swappable slot adjacent the left side of the vehicle, and a right hot-swappable slot adjacent the right side of the vehicle;
wherein the set of battery interfaces includes a left battery interface disposed within the left hot-swappable slot and a right battery interface disposed within the right hot-swappable slot; and
wherein the left battery interface and the right battery interface have a uniform geometry enabling any battery of the set of batteries to physically and electrically blind mate with either the left battery interface or the right battery interface.

17. Battery assembly for an electric vehicle, the battery assembly comprising:
a battery chassis defining a set of hot-swappable slots to house a set of batteries which stores electric power for the electric vehicle;
a door constructed and arranged to cover (i) a set of slot openings to the set of hot-swappable slots defined by the battery chassis and (ii) the set of batteries when the set of batteries is housed within the set of hot-swappable slots; and
hardware which couples the door with the battery chassis.

18. A method of battery hot-swapping on an electric firefighting robotic vehicle, the method comprising:
inserting a first set of batteries into a set of hot-swappable slots via a back of the electric firefighting robotic vehicle;
after the electric firefighting robotic vehicle has discharged electric power from the first set of batteries during firefighting robotic vehicle operation, removing a battery of the first set of batteries from a hot-swappable slot of the set of hot-swappable slots via the back of the electric firefighting robotic vehicle; and
inserting a replacement battery from a second set of batteries in place of the battery removed from the hot-swappable slot, the electric firefighting robotic vehicle operating based on electric power from at least the replacement battery following insertion of the replacement battery.

19. The method of claim 18, further comprising:
while the replacement battery from the second set of batteries remains inserted in place of the battery removed from the hot-swappable slot, removing another battery of the first set of batteries from another hot-swappable slot of the set of hot-swappable slots via the back of the electric firefighting robotic vehicle; and
inserting another replacement battery from the second set of batteries in place of the other battery removed from the other hot-swappable slot.
